(19) United States
(12) Patent Application Publication
(10) Pub. No.: US 2024/0317649 A1
(43) Pub. Date: Sep. 26, 2024

(54) PROCESS FOR PRODUCING PHOSPHATE FERTILIZER WITH MICRONIZED SULFUR

(71) Applicant: Sulvaris Inc., Calgary (CA)

(72) Inventors: David Kuehn, Calgary (CA); Mark Styles, Calgary (CA)

(21) Appl. No.: 18/611,176

(22) Filed: Mar. 20, 2024

Related U.S. Application Data
(60) Provisional application No. 63/453,363, filed on Mar. 20, 2023.

(51) Int. Cl. C05B 1/04; C05B 19/02; C05G 5/12

(52) U.S. Cl. CPC C05B 1/04; C05B 19/02; C05G 5/12

(57) ABSTRACT

Embodiments herein generally relate to a process for producing a solid phosphate fertilizer comprising micronized elemental sulfur. The process of producing a solid fertilizer comprises the steps of: (a) combining micronized sulfur with one or both of phosphate rock and phosphoric acid; (b) reacting the phosphate rock and phosphoric acid to produce TSP mixed with micronized sulfur particles; and (c) granulating the TSP and micronized sulfur into fertilizer granules.

### CROSS-RELATED REFERENCES

The present application claims the priority benefit of U.S. Provisional Application No. 63/453,363, filed on Mar. 20, 2023, the entire contents of which are incorporated herein by reference.

### FIELD OF THE INVENTION

This invention relates to a process for producing a solid phosphate fertilizer comprising micronized elemental sulfur.

### BACKGROUND

Phosphorus and sulfur are both essential nutrients for plant growth and may be added to soil in the form of various fertilizers.

Water soluble sulfate fertilizers are not desirable as its uptake suffers from over dissolution, as well as uncontrolled release and leaching, thereby leading to poor returns on farm input investment. Elemental sulfur is preferred, however when applied to soil in the form of particles greater than 100 micron size, the sulfur is very slow in reaching the roots of plants. Sulfur in its elemental form is insoluble in water and hence cannot be absorbed by the roots of plants. It is converted by microbial action into water soluble sulfate which is subsequently readily absorbed by plant roots.

Conversion of particulate elemental sulfur into sulfate-sulfur is considerably more effective when the particles are small, particularly at a particle size less than about 30 microns, a size range commonly referred to as micronized sulfur. When applied to soil where plants are grown, micronized sulfur can provide the plants with nutrients in the same season of application, and as such, micronized sulfur has value and application in the fertilizer industry.

Triple superphosphate (TSP) was one of the first high-analysis phosphorus (P) fertilizers that became widely used. It is known as calcium dihydrogen phosphate and as monocalcium phosphate, [Ca(H₂PO₄)₂·H₂O].

In producing TSP, it is desirable to maximize the conversion of rock phosphate (P₂O₅) to an available form (water soluble or citrate soluble P₂O₅) with the minimum quantity of phosphoric acid, because phosphoric acid P₂O₅ is more expensive than rock P₂O₅. To achieve this, it is helpful to predict the stoichiometry of the system, but this is difficult due to the complicated chemistry and is only possible to do this approximately. The actual quantities of rock and acid required can only be obtained by experiment.

The quantities of acid and rock required are traditionally expressed as an acid P₂O₅ to rock P₂O₅ ratio. The ratio preferably allows for a small quantity of acid in excess of stoichiometric requirements with the result that the final matured product will always contain a free acid P₂O₅ content. If a small excess of free acid is not maintained, the monocalcium phosphate can, under certain conditions of water content and temperature, revert to calcium diphosphate. Thus, by maintaining a free acid content in the TSP, the reversion of the water-soluble monophosphate to the water insoluble calcium diphosphate is prevented or reduced. In practice, sufficient phosphoric acid remains in the matured product to give a free acid P₂O₅ content of 3-5%. Using a large excess of rock is wasteful since this will pass through the process unchanged. Using a large excess of phosphoric acid would make the product sticky and result in material handling problems, in addition to producing a highly acidic fertilizer product.

### SUMMARY OF THE INVENTION

In some aspects, this disclosure relates to a process of producing a solid fertilizer comprising TSP and micronized sulfur.

In at least one broad aspect, there is provided a process of producing a solid fertilizer comprising the steps of: (a) combining micronized sulfur with one or both of phosphate rock and phosphoric acid; (b) reacting the phosphate rock and phosphoric acid to produce TSP mixed with micronized sulfur particles; and (c) granulating the TSP and micronized sulfur into fertilizer granules.

In some examples, the micronized sulfur is mixed with ground phosphate rock having a particle size of 80% <200 mesh (75 micron).

In some examples, the micronized sulfur is mixed with phosphoric acid having a concentration of about 35% to about 54%.

In some examples, the micronized sulfur has a mean particle size of less than about 30 microns, 10 microns, or 5 microns.

In some examples, the micronized sulfur is added as a dispersion in an aqueous dispersant solution.

In some examples, the dispersant comprises a surfactant, which can be an anionic surfactant or a non-ionic surfactant.

In some examples, the phosphate rock can be igneous or sedimentary in origin.

In some examples, the process further comprises adding calcium carbonate to step (b) to allow a faster reaction.

In some examples, the calcium carbonate is added in a range of about 2 to about 3 wt %.

In some examples, step (b) involves adding an excess of phosphoric acid relative to phosphate rock.

In some examples, the acid to rock ratio is in a range of between about 2.2 to about 3.2. In some examples, the acid to rock ratio is in a range of about 2.5 to about 2.8.

In some examples, the process further comprises mixing at least one micronutrient or secondary nutrient, or a combination of micronutrients and/or secondary nutrients, which may take place before or after step (b). In some embodiments, the micronutrient or secondary nutrient may comprise zinc, calcium, magnesium, boron, iron, copper, manganese, molybdenum, sodium, cobalt, chlorine, or selenium.

In another broad aspect, there is provided a fertilizer product comprising granules of: (i) solid triple superphosphate (TSP), and (ii) micronized sulfur in a range of between 1 to 50% by weight of the fertilizer product.

In some examples, the amount of micronized sulfur is in a range of approximately 5% and 25% by weight of the fertilizer product. In some examples, the amount of sulfur is in a range of approximately 5% and 15% by weight of the fertilizer product.

In some examples, the product further comprises at least one micronutrient or secondary nutrient, or a combination of micronutrients and/or secondary nutrients.

In some examples, the product comprises one or more of zinc, calcium, magnesium, boron, iron, copper, manganese, molybdenum, sodium, cobalt, chlorine, or selenium.

### DETAILED DESCRIPTION

As used herein, micronized sulfur particles are those which have a mean particle diameter of less than about 30 microns. Micronized elemental sulfur particles may be produced by any suitable method. For example, basic methods of production of micronized sulfur are described in U.S. Pat. No. 8,679,446, or U.S. patent application Ser. No. 17/418,180, the entire contents of which are incorporated herein by reference, where permitted.

It is preferred that the micronized sulfur have a mean particle size of less than about 20 microns, and more preferably less than about 15 microns, and more preferably less than about 10 microns or less than about 5 microns.

As used herein, “phosphate rock” is a naturally occurring ore which contains phosphate minerals. Its main constituent is fluorapatite or apatite, a calcium phosphate mineral primarily extracted from sedimentary marine deposits, with a small amount obtained from igneous sources.

As described in further detail below, one aspect disclosed comprises a method to produce a solid fertilizer product which comprises TSP and micronized elemental sulfur. The manufacture of TSP involves the reaction of phosphate rock with phosphoric acid. The major component of phosphate rock is fluorapatite Ca₃(PO₄)₂·CaF₂.

Ca₃(PO₄)₂+4H₃PO₄+3H₂O→3Ca(H₂PO₄)₂·H₂O Equation 1

CaF₂+2H₃PO₄+H₂O→Ca(H₂PO₄)₂·H₂O+2HF Equation 2

Therefore, in one aspect, disclosed is a method comprising the step of mixing micronized sulfur with at least one of phosphate rock or phosphoric acid, prior to their reaction with each other. The final product quality and processing conditions vary with both acid and rock analyses. In some embodiments, phosphate rock may comprise any phosphate rock from any suitable geologic deposit.

In some embodiments, the micronized sulfur is added to ground phosphate rock as a dispersion of particles in an aqueous solution with a dispersant for dispersing the micronized sulfur within the suspension or dispersion. The dispersant may comprise an anionic, cationic, amphoteric, or non-ionic surfactant, or combinations thereof. In some embodiments, the surfactant comprises an anionic surfactant such as naphthalene sulfonate, or carboxymethyl cellulose. Suitable anionic surfactants include, but are not limited to, lignin derivatives such as lignosulphonates, aromatic sulphonates and aliphatic sulphonates and their formaldehyde condensates and derivatives, fatty acids/carboxylates, sulphonated fatty acids and phosphate esters of alkylphenol-, polyalkyleryl- or alkyl-alkoxylates. Suitable cationic surfactants include, but are not limited to, nitrogen-containing cationic surfactants. Alternatively, the surfactant may comprise a nonionic surfactant such as an alkylphenol ethoxylate (e.g. octylphenol ethoxylate). In one embodiment, the dispersant comprises a non-ionic surfactant. Suitable non-ionic surfactants for use in the present invention include alkoxylated fatty alcohols, alkoxylated fatty acids, alkoxylated fatty ethers, alkoxylated fatty amides, alcohol ethoxylates, nonylphenol exthoxylates, octylphonel ethoxylates, ethoxylated seed oils, ethoxylated mineral oils, alkoxylated alkyl phenols, ethoxylated glycerides, castor oil ethoxylates, and mixtures thereof.

The mixture is then agitated or mixed to evenly disperse the micronized sulfur with the ground phosphate rock.

In another embodiment, the micronized sulfur is added to phosphoric acid as a suspension/dispersion of particles in an aqueous solution with a dispersant. and agitated to evenly disperse the micronized sulfur in the liquid phosphoric acid. Along with agitation, the dispersant ensures minimal settling of the micronized sulfur dispersion.

In some embodiments, sulfur is added in an amount to provide a TSP/sulfur product comprising about 1% to about 50% sulfur by weight, preferably between about 5% to about 25%. In some preferred embodiments, the amount of sulfur may vary between about 5 to about 15% by weight of the final product. The amount of sulfur added can be estimated based on the mass of the input raw materials minus the mass of fluorine and carbon dioxide that is expected to be vented during the reaction.

In some embodiments, one or a combination of micronutrients or secondary nutrients such as zinc, calcium, magnesium, boron, iron, copper, manganese, molybdenum, sodium, cobalt, chlorine, or selenium can be added into the mix to be incorporated into the TSP/sulfur product.

There are four main inter-dependent operating variables in a process to produce TSP by reacting phosphate rock and phosphoric acid. They are: a) Acid P₂O₅ to Rock P₂O₅ Ratio; b) Rock Particle Size; c) Acid Concentration; and d) Reaction Temperature.

These variables for the phosphate rock may be adjusted depending on rock reactivity to ensure that a slurry suitable for feeding to a granulator, either through the run-of-pile which is cured before granulation or slurry method which is cured after granulation, can be produced in the reactor system and the chemical quality of product is acceptable. Granulation and drying properties of the resulting product are downstream operations and may be substantially dependent on the production of a satisfactory slurry.

The effect of the operating variables mentioned above can be summarized as follows:

Acid P₂O₅ to rock P₂O₅ ratio is approximately dictated by the stoichiometry of acid and rock analyses. In TSP production it is essential to operate with a slight excess of acid above the stoichiometry to maximize available P₂O₅ by maintaining a positive driving force for reaction. Thus, the range of acid to rock P₂O₅ ratio is between about 2.2 to 3.2 (i.e., 70-75% of P₂O₅ from the acid). In preferred embodiments, the ratio may be between about 2.5 to about 2.8, such as 2.65. The range of the P₂O₅ to CaO ratio is between about 1.8 to 2.7.

Rock grind is selected to achieve the required degree of reaction and product quality. For any solid/liquid reaction system, particle size and hence reaction surface area affects reaction rate. The rock grind for TSP production for a sedimentary phosphate is preferably 80%<200 mesh (75 micron) but may vary as needed in respect of different grades and reactivities of phosphate rock. For rocks that are known to be very reactive, standard rock grind was used. Less reactive rocks may benefit from a finer grind, while more reactive grinds may benefit from a coarser grind.

Acid concentration of the phosphoric acid added to the phosphate rock to create a slurry is fixed by the need to maintain a sufficient reaction rate and the need to ensure that slurry produced is maintained in a sufficiently fluid state to enable mixing and pumping. Although theoretically available as a control parameter it is not particularly practical. A lower limit of about 40% P₂O₅ is dictated by the need to avoid excess water in the system. An upper limit of about 54% P₂O₅ is dictated by the abilities of forced circulation evaporation equipment and the requirement to have sufficient water present to allow reaction to proceed.

Reaction temperature for TSP production is based on the optimization of two conflicting requirements; the required equilibrium value and the requirement to maintain slurry in a fluid state. One skilled in the art may readily determine a suitable process temperature having regard to at least these factors.

Neither phosphate rock nor phosphoric acid are pure chemicals and as a result several side reactions will occur which can have significant effects on both the stoichiometry of the reaction system and the product quality.

Fe₂O₃+2H₃PO₄→2FePO₄H₂O+H₂O Equation 3

Al₂O₃+2H₃PO₄→2AlPO₄·H₂O+H₂O Equation 4

CaCO₃+2H₃PO₄→Ca(H₂PO₄)₂H₂O+CO₁ Equation 5

Ca₃(PO₄)₂+2H₂SO₄+H₂O→Ca(H₂PO₄)₂·H₂O+CaSO₄ Equation 6

4HF+SiO₂→SiF₄+2H₂O Equation 7

SiF₄+4H₂O→Si(OH)₄+2H₂SiF₆ Equation 8

All these reactions occur during the processing of phosphate rock into TSP and affect the processing and chemical quality of the final product. The iron and aluminum phosphates produced (Equations 3 & 4), although water insoluble, are citrate soluble which at least partly explains the reason for citrate solubility of TSP always being greater than water solubility. The presence of calcium carbonate in rock (equation 5) has been found to be beneficial in processing due to its conversion to carbon dioxide, which tends to aerate the reacting mass and allows the reaction to proceed at a faster rate. In some embodiments, small quantities (2 to 3%) of calcium carbonate may be added to the reaction especially where rocks have low (<1%) carbonate content.

Equation 6 arises from the fact that all wet process phosphoric acid contains residual sulfuric acid; the calcium sulfate produced merely acts as a diluent in the final product. The fluoride content of the rock is initially converted to hydrogen fluoride gas (equation 2) which then reacts with “active” or soluble silica to produce silicon tetrafluoride (equation 7). SiF₄ is a noxious gas and it is known that this gas should be removed and not allowed to escape into working areas or the atmosphere. Reaction gases are ducted to a scrubber where the SiF₄ is converted to fluorosilicic acid (equation 8).

The micronized sulfur remains intact and does not react during these reactions as it is incorporated into the resulting TSP. Adding micronized sulfur prior to the acid/rock reaction also more uniformly distributes the micronized sulfur throughout the granule and improves product physical characteristics which impacts handling as compared to adding it after reaction.

The TSP which includes evenly dispersed micronized sulfur and may include other components in the mixture may then be granulated using conventional methods and equipment. For example, the mixture may comprise a disintegrant for aiding disintegration of the granule when applied to soil. The disintegrant may comprise a water-soluble binder, as is well known in the art.

### EXAMPLES

The following examples are provided to illustrate embodiments of the invention and are not intended to limit the claimed invention in any way.

### Analysis of Phosphate Rock

Phosphate rock was used, having the following analysis:

TABLE 1
Rock Element Analysis

| Element | Analyses % |
|---|---|
| P₂O₅ | 30.4 |
| CaO | 47.2 |
| Fe₂O₃ | 0.30 |
| Al₂O₃ | 0.49 |
| MgO | 0.47 |
| Insol (SiO₂) | 3.0 |
| MER * | 0.41 |

* MER = (Fe₂O₃ + Al₂O₃ + MgO)/P₂O₅

TABLE 2
Phosphate Rock Analysis

| Rock Analysis | Rock Sample |
|---|---|
| % P₂O₅ | 30.4 |
| % CaO | 47.2 |
| MER of rock | 0.041 (low) |
| (% Al₂O₃ + % Fe₂O₃ + MgO)/P₂O₅ | |
| CaO/P₂O₅ ratio | 1.55 (typical) |
| Rock Grind | Fine grind for TSP |
| | 80% <200 mesh (75 micron) |

### Analysis of Phosphoric Acid

Low concentration phosphoric acid recovered from another process was concentrated by vacuum evaporation and had the following analyses.

TABLE 3
Phosphoric Acid Analysis

| | Analyses before | Analyses after |
|---|---|---|
| Element | Concentration % | Concentration % |
| P₂O₅ | 27.7 | 41.9 |
| Fe₂O₃ | 0.27 | 0.46 |
| Al₂O₃ | 0.19 | 0.36 |
| MgO | 0.33 | 0.54 |
| SG | 1.28 | 1.42 |

### Test Production

The general test procedure involves:
Placing 100 g of ground rock in a beaker. If not fully dried, cover each beaker with aluminum foil and place in a 65° C. oven the day before the test is to take place.
Place a calculated weight of phosphoric acid into each a 1000 mL beaker.
Start the timer and under a fume hood add one batch of rock to the acid. Mix vigorously with rod for about 30 seconds to achieve homogeneity.
Record the maximum temperature of the TSP slurry, the consistency, the maximum and the final settled volume of the slurry obtained along with any remarks. Each test is done in triplicate and then combined.
After the slurry has settled, transfer the material to a pan and place in a 65° C. oven.
After 10 minutes, stir/grind the solid material to remove large lumps and place the material back in the oven overnight at 65° C.
On the next day, remove the TSP from oven and crush to pass a 4 mm screen.
Submit samples for analysis.
After the best operating conditions have been found, repeat above tests with micronized sulfur addition at two dosages (10% and 15%). The sulfur will first be thoroughly mixed with the rock and then the rock/sulfur mixture added to acid at step.

Three series of tests were performed, (a) Series 1—Tests 1 to 3—Initial tests making TSP without sulfur addition; (b) Series 2—Tests 4 to 5—TSP with micronized sulfur (avg particle-size distribution (PSD)=<10 microns) addition made with a non-ionic surfactant; and (c) Series 3—Tests 6 to 7—TSP with micronized sulfur (avg PSD=<10 microns) addition made with an anionic surfactant.

In the first series of tests (Tests 1-3), the acid/rock ratio was varied to find an optimum recipe (i.e., an economic, yet practical operation while still making high grade TSP). Based on the results from these tests, a mid-range (2.65) acid/rock ratio was chosen for the next series of tests with sulfur addition.

The second series of tests (Tests 4 and 5) used an estimated 10% and 15% (by weight) of micronized sulfur addition with the same mid-range acid/rock recipe as used in Test 2. Clumping of sulfur in the finished product granules was visible. Due to the clumping and agglomeration, full analysis was not performed.

The third series of tests (Tests 6 and 7) repeated the recipe used in Tests 4 and 5, but with a batch of micronized sulfur produced with an anionic surfactant. The sulfur was more homogenously distributed in the granules than compared to the micronized sulfur produced using a non-ionic surfactant.

When the sulfur is first mixed with the phosphoric acid followed by thoroughly mixing with the rock, some segregation of the sulfur occurred when mixing was not present, but no noticeable difference in the reaction whether a non-ionic or anionic surfactant was used.

Table 4 below summarizes the conditions and the results for Tests 1-3 and 6-7:

TABLE 4
TSP Test Conditions and Results

| | Parameter/Test # | | | | |
|---|---|---|---|---|---|
| | 1 | 2 | 3 | 6 | 7 |
| | Test Description | | | | |
| | Low A/R | Med A/R | High A/R | 10% S | 15% S |
| Acid/Rock ratio | 2.40 | 2.65 | 2.90 | 2.65 | 2.65 |
| Acid % P₂O₅% | 42% | 42% | 42% | 42% | 42% |
| Acid weight g | 174 | 192.5 | 211 | 192.5 | 192.5 |
| Rock weight g | 100 | 100 | 100 | 100 | 100 |
| Sulfur weight g | 0.0 | 0.0 | 0.0 | 26.2 | 41.6 |

TEST RESULTS

| | | | | | |
|---|---|---|---|---|---|
| Max Temp ° C. | 48 | 47 | 50 | 33 | 31 |
| Set Volume mL | 440 | 480 | 500 | 775 | 775 |
| % Total P₂O₅ | 47.9 | 48.9 | 49.1 | 42.8 | 39.5 |
| % Citrate insoluble | 0.21 | 0.13 | 0.12 | 0.62 | 0.50 |
| P₂O₅ | | | | | |
| % Water soluble | 43.8 | 45.7 | 46.3 | 39.6 | 36.9 |
| P₂O₅ | | | | | |
| % Free acidity | 1.0 | 1.4 | 2.2 | 1.6 | 1.8 |
| % Free water H₂O | 3.9 | 4.1 | 5.2 | 3.2 | 3.8 |
| % Total sulfur | 1.22 | 1.32 | 1.17 | 13.4 | 18.9 |
| % Sulfur as SO4 | 1.22 | 1.27 | 1.13 | 1.0 | 0.9 |
| % Elemental sulfur | Nil | Nil | Nil | 12.4 | 18.0 |

The TSP produced with micronized sulfur (TSP-S) produced from the finer and more dispersed sulfur used in Tests 6 and 7 appeared much more homogeneous (i.e., the presence of sulfur was significantly less noticeable) than in Tests 4 and 5, which used coarser more agglomerated sulfur.

The TSP-S produced with sulfur had a slightly reduced recovery than the TSP produced without sulfur. For example, in Test 2, the citrate insoluble P₂O₅ was only 0.13% out of 48.9% total P₂O₅, indicating a “recovery” of useful P₂O₅ of 99.7%, which is extremely high. In Tests 6 and 7, the recoveries of useful P₂O₅ were 98.4% and 98.6%, respectively, which is still considered extremely high.

The estimated amount of sulfur needed to hit 10% and 15% was overestimated, but no negative effects were observed. The amount of sulfur added was estimated based on the mass of the raw materials minus the amount of fluorine and carbon dioxide that was expected to be vented during the reaction.

Even with the large amount of sulfur addition, the available and water soluble P₂O₅ analysis achieved on Test 6 were still not far from the target values for TSP (>90%). There was no problem achieving the other typical specifications of free acidity and free moisture.

TABLE 5
TSP Product Analysis

| | Test 2 | Test 6 | Test 7 |
|---|---|---|---|
| TSP Product Analysis | No S added | 10% S | 15% S |
| Acid/rock ratio | 2.65 | 2.65 | 2.65 |
| (based on contained P₂O₅) | | | |
| % P₂O₅, total | 48.9 | 42.8 | 39.5 |
| % P₂O₅, citrate insoluble (Cl) | 0.13 | 0.62 | 0.50 |
| % Available P₂O₅₍₁₎ | 48.8 | 42.2 | 39.0 |
| % P₂O₅, water soluble (WS) | 45.7 | 39.6 | 36.9 |
| % Free acidity | 1.4 | 1.6 | 1.8 |
| % Elemental sulphur | Nil | 12.4 | 18.0 |

### Interpretation

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of +5%, +10%, +20%, or +25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited value or range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “between”, “up to”, “at least”, “greater than”, “less than”, “more than”, “or more”, and the like, include the number(s) recited and such terms refer to ranges that can be subsequently broken down into sub-ranges as discussed above. In the same manner, all ratios recited herein also include all sub-ratios falling within the broader ratio.

1. A process of producing a solid fertilizer comprising the steps of:
(a) combining micronized sulfur with one or both of phosphate rock and phosphoric acid;
(b) reacting the phosphate rock and phosphoric acid to produce triple superphosphate (TSP) mixed with micronized sulfur particles; and
(c) granulating the TSP and micronized sulfur into fertilizer granules.

2. The process of claim 1, wherein the micronized sulfur is mixed with ground phosphate rock having a particle size of 80%<200 mesh (75 micron).

3. The process of claim 1, wherein the micronized sulfur is mixed with phosphoric acid, the acid having a concentration in a range of about 35% to about 54%.

4. The process of claim 1, wherein the micronized sulfur has a mean particle size of less than about 30 microns, 10 microns, or 5 microns.

5. The process of claim 1, wherein the micronized sulfur is added as a dispersion in an aqueous dispersant solution.

6. The process of claim 5, wherein the dispersant comprises a surfactant, such as an anionic surfactant.

7. The process of claim 1, further comprising adding calcium carbonate to step (b).

8. The process of claim 7, wherein the calcium carbonate is added in a range of approximately 2 to 3% wt.

9. The process of claim 1, wherein step (b) involves adding an excess of phosphoric acid relative to phosphate rock.

10. The process of claim 9, wherein the acid to rock ratio is in a range of between about 2.2 to 3.2.

11. The process of claim 10, wherein the acid to rock ratio is in a range of about 2.5 to 2.8.

12. The process of claim 1, after step (b), further mixing one or a combination of micronutrients and secondary nutrients.

13. The process of claim 12, wherein the one or a combination of micronutrients and secondary nutrients comprises one or a combination of zinc, calcium, magnesium, boron, iron, copper, manganese, molybdenum, sodium, cobalt, chlorine, or selenium.

14. A fertilizer product comprising granules of: (i) solid triple superphosphate (TSP), and (ii) micronized sulfur in a range of between 1 to 50% by weight of the fertilizer product.

15. The product of claim 14, where the amount of micronized sulfur is in a range of approximately 5% and 25% by weight of the fertilizer product.

16. The product of claims 14, wherein the amount of micronized sulfur is in a range of approximately 5% and 15% by weight of the fertilizer product.

17. The product of claim 16, wherein the product further comprises one or a combination of micronutrients or secondary nutrients.

18. The product of claim 17, wherein the one or a combination of micronutrients or secondary nutrients comprises one or more of zinc, calcium, magnesium, boron, iron, copper, manganese, molybdenum, sodium, cobalt, chlorine, or selenium.
